(19) United States
(12) Patent Application Publication
(10) Pub. No.: US 2006/0233091 A1
(43) Pub. Date: Oct. 19, 2006

(54) Storage device having storage cells having a size less than a write light wavelength

(76) Inventors: David M. Schut, Philomath, OR (US); Robert N. Bicknell, Corvallis, OR (US); Michael S. Setera, Albany, OR (US); Timothy M. Mellander, Albany, OR (US); Robert W. Bass, Scio, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/096,312

(22) Filed: Apr. 1, 2005

(51) Int. Cl. G11B 7/24

(52) U.S. Cl. 369/275.1

(57) ABSTRACT

A storage device comprises a substrate having a recording layer, the recording layer having plural regions associated with respective plural storage cells. A light source generates write light having a first wavelength to write to the storage cells, wherein the storage cells have a size less than the first wavelength.

### BACKGROUND

Various types of storage media can be used in computers and other types of electronic devices. Examples of storage media include integrated circuit storage devices, such as dynamic random access memories (DRAMs), static random access memories (SRAMs), electrically erasable and programmable read-only memories (EEPROMs), and so forth. Storage media also include magnetic and optical-based storage media, such as floppy disks, hard disks, compact disks (CDs), and digital versatile disks (DVDs).

Optical DVD technology has enabled the storage of relatively large amounts of data on a relatively small disk. The continued trend towards even higher storage densities on optical storage media such as DVDs has led to development of the Blu-Ray technology, which uses blue-violet laser light instead of red laser light (associated with conventional DVD technology) to write and read bits on the DVD. Blue-violet laser light has a shorter wavelength than red laser light, which enables better focusing and greater precision of the laser light when writing to and reading from storage cells on the optical medium. The use of shorter wavelength blue-violet laser light enables higher density arrangement of data on an optical medium.

Traditionally, storage cells on optical media are diffraction limited, which means that the storage cell sizes are larger than the wavelength of the laser light used to write to the storage cells. Diffraction limited storage media are therefore unable to achieve even greater storage density.

### BRIEF DESCRIPTION OF THE DRAWINGS

FIG. 1 illustrates a portion of a storage device according to an embodiment of the invention.

FIG. 2 illustrates the use of laser to write data to and read data from a storage device, according to an embodiment.

FIG. 3 is a timing diagram showing laser light pulses for writing storage cells in the storage device, according to an embodiment.

FIG. 4 is a graph illustrating a temperature profile of a storage cell region in response to a write laser pulse, according to an embodiment.

FIG. 5 is a block diagram of an example system that incorporates a storage device according to an embodiment.

### DETAILED DESCRIPTION

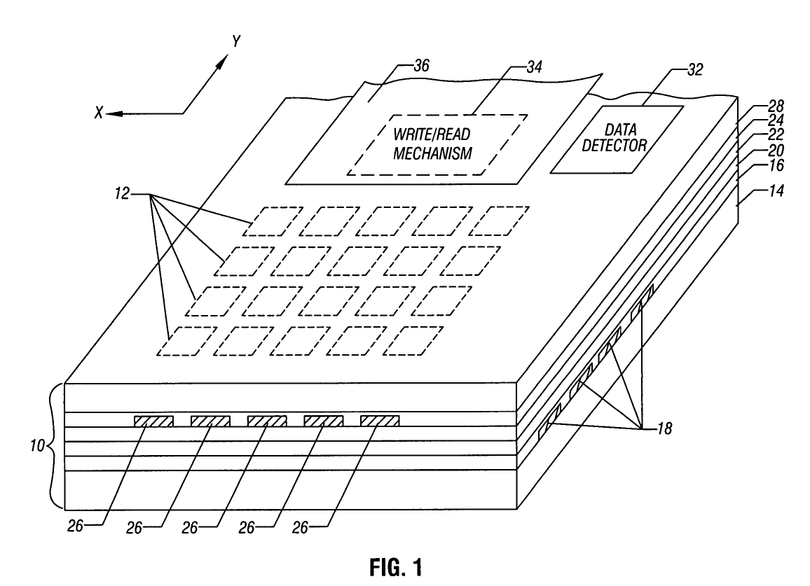

FIG. 1 shows a storage device according to an embodiment that includes a storage substrate 10 that contains a plurality of storage cells 12. The storage substrate 10 includes a support structure 14 over which several layers are formed. A first layer 16 formed over the support structure 14 includes a number of electrical electrodes or conductors 18 that extend generally along a first direction (indicated as being the X direction in FIG. 1). According to one embodiment, the conductors 18 are formed of a reflective, electrically conductive material (e.g., aluminum silicon).

A semiconductor layer 20, such as a p-type silicon layer, is formed over the first layer 16. A phase-change layer 22 is formed over the semiconductor layer 20. In one example, the phase-change layer 22 is formed of an n-type material. In an alternative embodiment, the phase-change layer 22 is formed of a p-type material, while the semiconductor layer 20 is formed of an n-type material. The layers 20 and 22 have different doping types (p-doping type or n-doping type) to form a p-n junction.

Examples of the phase-change material used to form the phase-change layer 22 include In₂Se₃, InSe, Ga₂Se₃, GaSbTe, GbSb, and AgGaSbTe. Other phase-change materials can be used in other embodiments.

Another layer 24 is formed over the phase-change layer 22, with the layer 24 including electrodes 26 that extend along a second direction, indicated as being the Y direction in FIG. 1. The X and Y directions in FIG. 1 are generally perpendicular to each other. In a different embodiment, electrodes 18 extend in the Y direction, while the electrodes 26 extend in the X direction.

An anti-reflective coating and a protective layer 28 can be formed over the layer 24. The anti-reflective coating layer allows laser light, and optionally, electron beams to pass through to the phase-change layer 22 to perform writes and reads of the storage cells 12.

The layers of the storage substrate 10 depicted in FIG. 1 are provided for exemplary purposes. In other implementations, other arrangements and layers can be employed for the storage substrate 10.

The phase-change layer 22 is effectively a recording layer that is programmable to store data bits in respective storage cells 12. Each region of the phase-change layer 26 corresponding to a storage cell 12 has at least two phases, a crystalline phase and an amorphous phase. Alternatively, instead of an amorphous phase, two different crystalline phases can be used for storing data bits. When programmed to a first phase, a storage cell 12 contains a data bit having a first data state or logical value. However, if the phase-change layer portion of the storage cell 12 is programmed to have a second phase, then the storage cell 12 contains a data bit having a second, different data state or logical value.

A data detector 32 is provided on the storage substrate 10 to perform readback of the data bits contained in the storage cells 12. The data detector 32 is electrically connected to the electrodes 18 and 26 to detect a voltage across each pair of electrodes 18, 26. If a storage cell 12 contains a first data state, then the data detector 32 detects a first voltage. However, if a storage cell 12 contains a second data state, then the data detector 32 detects a second voltage. Although depicted as being one logical block 32, the data detector 32 can actually have multiple data detector circuits, one for each respective group (e.g., a column or row) of storage cells.

FIG. 1 also shows a write/read mechanism 34 that is provided on a second substrate 36. The second substrate 36 and the storage substrate 10 are movable with respect to each other to position the write/read mechanism 32 over selected storage cell(s) 12 to program (write) or read the storage cells. Note that either the second substrate 36 or the storage substrate 10, or both, can be movable to achieve relative motion between the write/read mechanism 34 and the storage cells 12. The write/read mechanism 34, according to one embodiment, includes laser light sources for propagating laser light onto the storage substrate 10 for purposes of performing writes and reads with respect to the storage cells 12. In one embodiment, the write/read mechanism 34 includes write laser sources (for performing writes) and read laser sources (for performing reads). Alternatively, the write/read mechanism 34 can include electron beam emitters (instead of read laser sources) that are used for performing reads, and write laser sources for performing writes. More generally, a read laser source or electron beam emitter in the write/read mechanism 34 is referred to as a “read illuminating beam generator” that is able to emit a laser light or an electron beam.

According to some embodiments of the invention, each write/laser source of the write/read mechanism 34 is able to write data bits onto the storage cells 12 that have sizes that are not diffraction limited. In other words, the write laser light source is able to write storage cells 12 that each has a size (“sub-wavelength size”) smaller than the wavelength of the laser light produced by the write laser source. Storage cells 12 that have sizes smaller than the wavelength of the write laser light are referred to as sub-wavelength storage cells. A storage cell has a size smaller than the wavelength of the write laser light if (1) the diameter of the storage cell, or (2) a width or length of the storage cell, or (3) any other dimension of the storage cell, is smaller than the wavelength of the write laser.

The ability to achieve a sub-wavelength storage cell is provided by generating a write laser pulse having a power amplitude and duration that does not cause phase change in portions of the phase-change layer 22 outside the phase-change layer region of a targeted storage cell, even though the phase-change layer region of the targeted storage cell is smaller than the wavelength of the write laser light. The characteristics of the write laser pulse that enable writing to and reading from sub-wavelength storage cells are described further below.

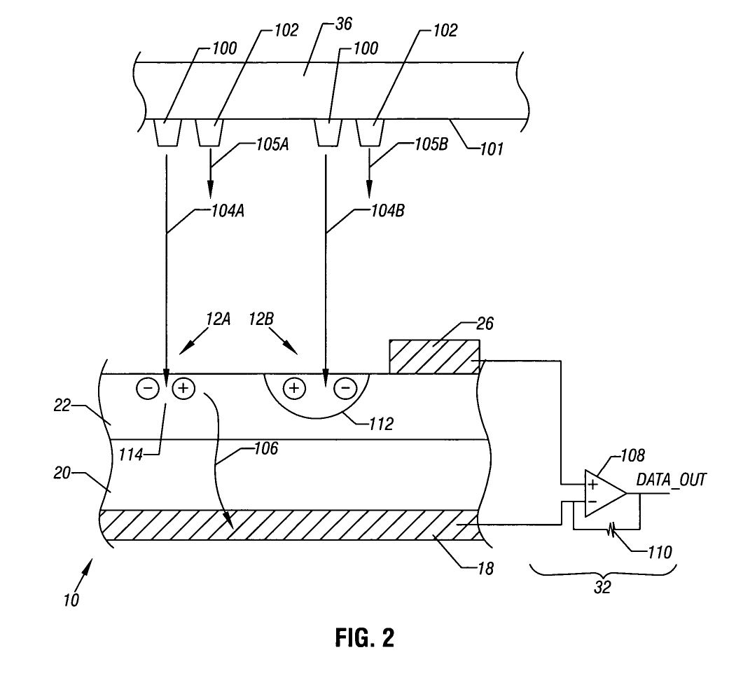

FIG. 2 is a side view of a portion of the storage substrate 10 and the second substrate 36. Write laser sources 102 are provided on a lower surface 101 of the second substrate 36. In addition, read illuminating beam sources 100 (which can be electron beam emitters or laser sources) are also formed on the lower side 101 of the second substrate 36. The write laser sources 102 and read illuminating beam sources 100 are part of the write/read mechanism 34 (FIG. 1). Although multiple write laser sources 102 and read illuminating beam sources 100 are depicted in FIG. 2, other embodiments can employ a single write laser source 100 and/or a single read illuminating beam source 102.

In one example embodiment, the write laser light produced by each write laser source 100 has a wavelength of about 399 nanometers (nm), while the read laser light produced by each read laser source has a wavelength of about 422 nm. Wavelengths of the write and read laser lights having approximately the exemplary wavelength values above are wavelengths of blue laser lights (which include blue laser light or blue-violet laser light). In other embodiments, other wavelengths can be used for the write and read laser lights.

In FIG. 2, a first write laser source 102 generates a laser light beam 105A to be directed at a first storage cell 12A, whereas a second write laser source 102 generates a second laser light beam 105A to be directed at a second storage cell 12B. FIG. 2 also depicts first and second read laser sources 100 generating respective first and second read laser light beams 104A, 104B. In the position depicted in FIG. 2, for performing a read, the read laser sources 100 are aligned with respect to storage cells 12A, 12B to enable the laser light beams 104A, 104B from the read laser sources 100 to impact respective storage cells 12A, 12B. To perform a write, the write laser sources 102 would be aligned with respect to the storage cells 12A, 12B (by relative motion of the storage substrate 10 and second substrate 36) to direct laser light beams 105A, 105B from the write laser sources 102 to the storage cells 12A, 12B.

In the example of FIG. 2, the write laser light beam 105A directed at the storage cell 12A causes the region of the phase-change layer 22 that is part of the storage cell 12A to either remain at, or change to, a first phase (e.g., a crystalline phase). On the other hand, the write laser light beam 105B directed at storage cell 12B causes the region of the phase-change layer 22 that is part of the storage cell 12B to remain at, or change to, a second phase (e.g., an amorphous phase). The region of the phase-change layer 22 that is part of the storage cell 12A is indicated as crystalline region 114, whereas the region of the phase-change layer 22 that is part of the storage cell 12B is indicated as amorphous region 112. In other examples, the storage cell 12A can be programmed to the amorphous phase, whereas the storage cell 12B can be programmed to the crystalline phase.

In the amorphous region 112 of the storage cell 12B, the read laser light beam 104A induces creation of electron-hole pairs. However, since electron-hole pairs in the amorphous region 112 tend to recombine at a relatively rapid rate, little or no current flows from the amorphous region 112 through the semiconductor layer 20 to the electrode 18 in response to the read laser light beam 104B. However, in the crystalline region 114, recombination of electron-hole pairs occurs at a slower rate than in the amorphous region 112; therefore, in response to the read laser light beam 104A, a current flow 106 is induced from the crystalline region 114 through the semiconductor layer 20 to the electrode 18. The p-type phase-change layer 22 and the n-type semiconductor layer 20, which are adjacent to each other, effectively provide a p-n junction that behaves as a diode.

In an alternative embodiment, a storage cell is programmable to two different crystalline phases—a first crystalline phase and a second crystalline phase. The two crystalline phases have different recombination rates for electron-hole carrier pairs (free carriers) so that different currents are induced in response to the read laser light beams 104A, 104B.

Current flow through the p-n junction causes a voltage drop across the diode represented by the p-n junction. The voltage drop occurs across electrodes 26 and 18. The electrode 26 is connected to the + input of an operational amplifier 108, whereas the electrode 18 is connected to the − input of the operational amplifier 108. The operational amplifier 108 is part of the data detector 32. The operational amplifier 108 checks for a voltage drop across electrodes 26 and 18. If a first voltage drop (corresponding to a first phase of the phase-change layer region of a selected storage cell) occurs between electrodes 26 and 18, the operational amplifier 108 outputs a first value to a signal Data_Out. However, if a second, different voltage drop (corresponding to a second phase of the phase-change layer region of a selected storage cell) across electrodes 26 and 18 is detected by the operational amplifier 108, then the operational amplifier 108 outputs a second value to the signal Data_Out. In one embodiment, a resistor 110 is part of a feedback loop associated with the operational amplifier 108. In other embodiments, other types of circuitry for detecting a voltage drop (or current) across the electrodes 26 and 18 can be employed. Although one operational amplifier 108 is depicted in FIG. 1, multiple operational amplifiers 108 can be part of the data detector 32 to detect data states of corresponding multiple storage cells.

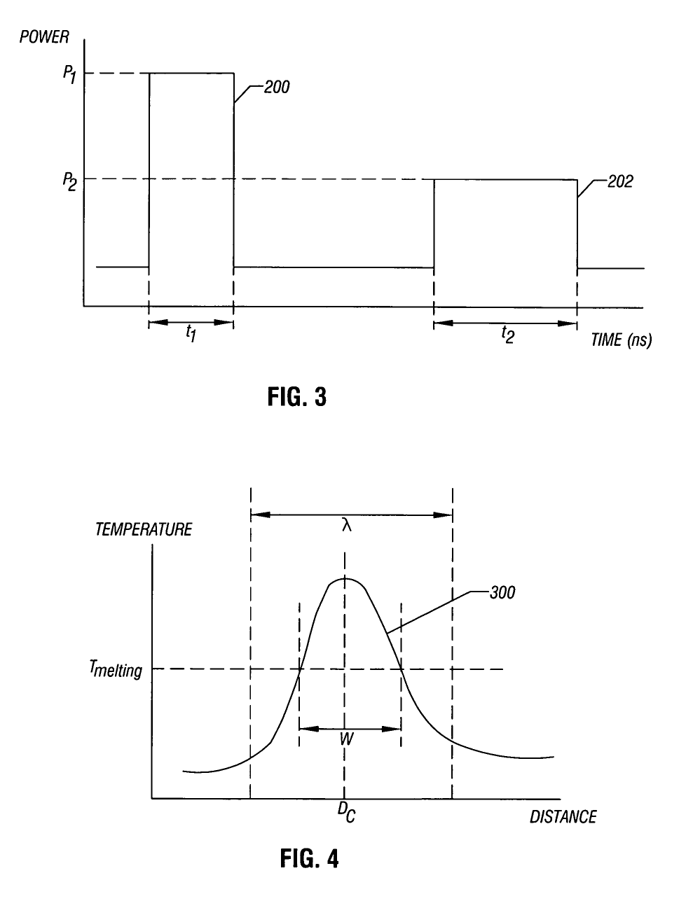

FIG. 3 is a timing diagram that illustrates two pulses 200, 202 of a write laser light beam for performing writes to a storage cell (or storage cells) of the storage substrate 10 (FIG. 1). The first pulse 200 (having a power amplitude P₁ and pulse width t₁) is used to program a storage cell to an amorphous phase. The second pulse 202 having power amplitude P₂ and pulse width t₂ is used to program the storage cell to the crystalline phase.

The power amplitude and pulse width of each of the pulses 200 and 202 depicted in FIG. 3 is selected to heat the phase-change layer region in a targeted storage cell such that temperature in the phase-change layer region has a temperature profile similar to profile 300 depicted in FIG. 4. The temperature profile depicted in FIG. 4 generally represents the temperature in the phase-change layer region of a storage cell as a function of distance. The temperature profile 300 has a generally Gaussian shape. In other words, the temperature profile 300 is generally a normal curve, which is a symmetrical bell-shaped curve of normal distribution. More generally, the temperature profile 300 has a generally bell-shaped curve. The peak of the generally bell-shaped curve (representing the maximum temperature induced in the phase-change layer region of a targeted storage cell) is located generally at, or near, the center of the storage cell (represented as point D_{C} in FIG. 4). The temperature away from this center or near center location D_{C} in the storage cell drops from the peak according to the generally bell-shaped curve of FIG. 4.

The wavelength of the write laser light is represented by λ As depicted in FIG. 4, a portion of the generally bell-shaped temperature profile is above the melting temperature (T_{melting}), represented by the horizontal dashed line, of the phase-change layer. The portion of the temperature profile above the melting temperature has a width W, which is smaller than the wavelength λ of the write laser light. As a result, in response to the write laser light, only the region of the phase-change layer where the temperature rises above T_{melting} is programmed. Therefore, the size (diameter, width, or other dimension) of a storage cell can be made as small as the width W depicted in FIG. 4. The value of the width W is smaller than the wavelength λ to enable formation of a sub-wavelength storage cell according to some embodiments.

In one example, a 399-nm write laser light pulse having power amplitude of 3.5 milliwatts (mW) and pulse width of 50 nanoseconds (ns) can be used to form storage cells with a diameter of about 170 nm. In other examples, the power amplitude can be adjusted between 2-10 mW, and the pulse widths can be varied between 10-50 ns, or greater. The values given above are for the purpose of example. In other implementations, other values for the power amplitude and pulse width of the write laser light can be used to effectively write to sub-wavelength storage cells.

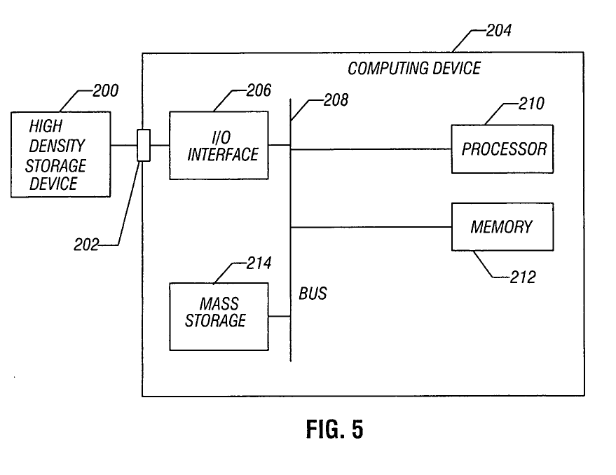

The storage device described above according to some embodiments can be packaged for use in a computing device 204 (e.g., desktop computer, portable or notebook computer, server computer, handheld device, consumer electronic device such as a camera and appliance, and so forth). For example, as shown in FIG. 5, the storage device according to some embodiments is referred to as a high-density storage device 200, which can be attached or connected to an I/O (input/output) port 202 of a computing device 204. The I/O port 202 can be a USB port, a parallel port, or any other type of I/O port. Inside the computing device 204, the I/O port 202 is connected to an I/O interface 206, which in turn is coupled to a bus 208. The bus 208 is coupled to a processor 210 and memory 212, as well as to mass storage 214. Other components may be included in the computing device 204. The arrangement of the computing device 204 is provided as an example, and is not intended to limit the scope of the invention. In alternative embodiments, instead of being coupled to an I/O port of the computing system, the high-density storage device 200 can be mounted (directly or through a socket) onto the main circuit board of the computing device 204.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A storage device comprising:
a substrate having a recording layer, the recording layer having plural regions associated with respective plural storage cells; and
a light source to generate write light having a first wavelength to write to the storage cells, wherein the storage cells have a size less than the first wavelength.

2. The storage device of claim 1, wherein the light source comprises a laser light source.

3. The storage device of claim 1, wherein the recording layer comprises a layer formed of a phase-change material.

4. The storage device of claim 1, wherein the write light causes heating of the recording layer region in a respective storage cell such that temperature in the recording layer region has a generally bell-shaped profile.

5. The storage device of claim 1, further comprising a second light source to generate read light having a second, different wavelength to enable reading of the storage cells.

6. The storage device of claim 5, further comprising read circuit to detect a current in the substrate induced by the read light in a storage cell.

7. The storage device of claim 6, wherein the substrate has a semiconductor layer adjacent the recording layer, the recording layer and semiconductor layer forming a p-n junction that provides a voltage in response to the current, the voltage detectable by the read circuit.

8. The storage device of claim 1, further comprising an electron beam emitter to emit electrons to enable reading of the storage cells.

9. The storage device of claim 1, wherein the recording layer region in each storage cell is programmable to one of a first phase and a second phase during a write.

10. The storage device of claim 9, wherein the first phase comprises an amorphous phase, and the second phase comprises a crystalline phase.

11. The storage device of claim 9, wherein the first phase comprises a first crystalline phase, and the second phase comprises a second crystalline phase.

12. A storage device comprising:
a support structure;
a recording layer formed over the support structure;
a write mechanism to write to storage cells in the recording layer by selectively forming, using laser light having a wavelength, amorphous regions and crystalline regions in respective storage cells, the write mechanism to write to the storage cells each having a size smaller than the wavelength of the laser light; and
a read circuit to detect electrical signaling in the amorphous and crystalline regions to read states of the storage cells.

13. The storage device of claim 12, further comprising a read light source to generate read laser light targeted at a region in the recording layer corresponding to a storage cell to induce generation of free carriers in the region,
the read circuit to detect a first electrical signal in response to the targeted region being an amorphous region, and the read circuit to detect a second, different electrical signal in response to the targeted region being a crystalline region.

14. The storage device of claim 13, wherein a difference between the first and second electrical signals is caused by the free carriers recombining at a higher rate in an amorphous region than in a crystalline region.

15. The storage device of claim 12, wherein the recording layer comprises a phase-change layer.

16. The storage device of claim 15, further comprising a semiconductor layer formed adjacent the phase-change layer, the semiconductor layer and recording layer to form a p-n junction.

17. The storage device of claim 16, wherein the phase-change layer contains a p-type material, and the semiconductor layer contains an n-type material.

18. The storage device of claim 16, wherein the phase-change layer contains an n-type material, and the semiconductor layer contains a p-type material.

19. A method of storing data in a storage device, comprising:
generating, with a laser source, a laser light targeted at a storage cell of the storage device, the storage cell including a region of a phase-change layer; and
programming the region in the storage cell to one of a first phase and a second phase,
wherein the laser light produced by the laser source enables programming of the region in the storage cell that has a size smaller than a wavelength of the laser light.

20. The method of claim 19, wherein generating the laser light comprises generating blue laser light.

21. The method of claim 19, further comprising:
generating a read illuminating beam targeted at the storage cell, the read illuminating beam to cause generation of free carriers in region of the storage cell; and
detecting a signal induced from the storage cell in response to the read illuminating beam to determine whether the region in the storage cell is programmed to the first phase or the second phase.

22. The method of claim 21, wherein programming the region in the storage cell comprises programming the region in the storage cell to an amorphous phase to represent a first data state, and programming the region in the storage cell to a crystalline phase to represent a second data state.

23. The method of claim 21, wherein programming the region in the storage cell comprises programming the region in the storage cell to a first crystalline phase to represent a first data state, and programming the region in the storage cell to a second crystalline phase to represent a second data state.

24. A system comprising:
a processor; and
a storage device coupled to the processor, the storage device comprising:
a support structure;
a recording layer formed over the support structure; and
a write laser source to generate a write laser light having a wavelength,
the write laser light to write to storage cells including regions of the recording layer, wherein the storage cells have a size less than the wavelength.

25. The system of claim 24, wherein the write laser source comprises a blue laser source.

26. The system of claim 24, wherein the regions in the storage cells are programmable by the write laser light to one of a first phase and a second phase.

27. The system of claim 24, wherein the storage cells have a diameter smaller than the wavelength.

28. The system of claim 24, wherein the storage cells have a length smaller than the wavelength.

29. The system of claim 24, wherein the storage cells have a width smaller than the wavelength.
